(19) United States
(12) Patent Application Publication
(10) Pub. No.: US 2026/0162362 A1
(43) Pub. Date: Jun. 11, 2026

(54) GRAPHICS PROCESSING UNIT WITH HEURISTIC ALGORITHM, OPERATING METHOD THEREOF, AND ELECTRONIC DEVICE

(71) Applicant: SAMSUNG ELECTRONICS CO., LTD., Suwon-si (KR)

(72) Inventors: Dooyeun HWANG, Suwon-si (KR); Arun Radhakrishnan, San Jose, CA (US); Junmo Park, Suwon-si (KR)

(73) Assignee: SAMSUNG ELECTRONICS CO., LTD., Suwon-si (KR)

(21) Appl. No.: 19/413,502

(22) Filed: Dec. 9, 2025

Related U.S. Application Data
(60) Provisional application No. 63/730,120, filed on Dec. 10, 2024.

(30) Foreign Application Priority Data
Sep. 12, 2025 (KR) 10-2025-0131128

(51) Int. Cl. G06T 15/80; G06T 1/20

(52) U.S. Cl. CPC G06T 15/80; G06T 1/20

(57) ABSTRACT

A shader engine device for performing shading includes an instruction buffer configured to store instructions, a controller configured to schedule execution of the per-wave instructions, an arithmetic logic unit (ALU) configured to perform a graphics operation, and a general-purpose register configured to store an intermediate value of the graphics operation. The controller is further configured to change a precision mode of the instructions to a high precision mode, based on heuristic precision modulated shading (PMS), the instructions being associated with a source operand of a branch.

### CROSS-REFERENCE TO RELATED APPLICATIONS

This application claims benefit of priority to U.S. Patent Provisional Application No. 63/730,120, filed on Dec. 10, 2024, in the U.S. Patent and Trademark Office, and, under 35 U.S.C. § 119, to Korean Patent Application No. 10-2025-0131128, filed on Sep. 12, 2025, in the Korean Intellectual Property Office, the disclosures of which are incorporated by reference herein in their entireties.

### BACKGROUND

### 1. Field

The present disclosure relates generally to graphics processing, and more particularly, to a graphics processing unit with a graphics pipeline using a heuristic algorithm and a new scalar instruction, an operating method of the graphics processing unit, and an electronic device.

### 2. Description of Related Art

Graphics processing units (GPUs) may perform a function of rendering graphics data in a computing device. Generally, GPUs may convert graphics data, corresponding to two-dimensional (2D) and/or three-dimensional (3D) objects, into 2D pixel representation to generate a frame for display. Examples of computing devices may include, but may not be limited to, embedded devices such as, for example, smartphones, tablet devices, wearable devices, as well as, personal computers (PCs), notebook computers, video game consoles, or the like. Embedded devices such as, but not limited to, smartphones, tablet devices, and wearable devices may be limited by relatively-low power consumption and/or a relatively-low operation processing capability, and as such, may be unable to provide similar graphic processing performance as workstations such as, but not limited to, PCs, notebook computers, and video game consoles, which may secure a sufficient memory space and/or processing power. However, recently, as portable devices such as, but not limited to, smartphones or tablet devices, may be widely distributed, the frequency of users attempting to perform graphic intensive activities, such as, but not limited to, playing a game, or viewing a movie or a drama, through their portable devices may have increased. Consequently, research by manufacturers of GPUs may be actively being conducted to potentially increase the performance and/or processing efficiency of GPUs in embedded devices, based on increases in demand from users of the embedded and/or portable devices.

Fragment shaders, from among shader modules that may perform a graphics pipeline may refer to shaders that may calculate a color and/or a depth value of a pixel. Since a human eye may be limited in distinguishing a color difference and/or a depth value difference of a pixel, rendering quality seen by human eyes may be maintained through a fragment shader. However, precision modulated shading (PMS) may have been introduced as a method that may decrease real operation complexity and/or the number of operations in order to potentially reduce power consumption. PMS may maintain a rendering quality of an image by variably cutting a mantissa part for an efficient floating point operation, and thereby, a power consumption and/or an amount of memory use may be reduced by decreasing the number of operations that may be performed. However, even when PMS is applied to a fragment shader, a result where the ratio of power consumption to performance may be degraded, and thus, there may exist a need for further improvements in graphic processing technology.

### SUMMARY

One or more example embodiments of the present disclosure provide a graphics processing unit that performs fragment shading by using a new scalar instruction and a heuristic algorithm for potentially preventing an abnormal branch, while improving operation efficiency and may thus improve performance without image corruption, when compared to related graphics processing units.

Further, one or more example embodiments of the present disclosure provide an operating method of the graphics processing unit, and an electronic device including the same.

According to an aspect of the present disclosure, a shader engine device for performing shading includes an instruction buffer configured to store instructions, a controller configured to schedule execution of the instructions, an arithmetic logic unit (ALU) configured to perform a graphics operation, and a general-purpose register configured to store an intermediate value of the graphics operation. The controller is further configured to change a precision mode of the instructions to a high precision mode, based on heuristic precision modulated shading (PMS), the instructions being associated with a source operand of a branch.

According to an aspect of the present disclosure, an operating method of a shader engine for performing shading includes determining setting values of heuristic PMS, determining whether a branch is in a control flow graph (CFG), based on the branch not being in the CFG, setting a precision mode of instructions of the CFG to a basic brain floating point (BF) mode, based on the branch being in the CFG, identifying a last branch in the CFG and setting the precision mode of the instructions of the CFG to the basic BF mode, based on execution of the last branch being completed, setting, to a high precision BF mode, a plurality of instructions of use-definition chain, from among the instructions of the CFG, corresponding to a use-definition chain of a source operand of the last branch, and performing refining on remaining instructions of the CFG excluding the plurality instructions of the use-definition chain.

According to an aspect of the present disclosure, an electronic device includes a memory, and a processor including a shader engine configured to perform a graphics pipeline. The shader engine is configured to determine setting values of heuristic PMS, determine whether a branch is in a CFG, based on the branch not being in the CFG, set a precision mode of instructions of the CFG based on a basic BF mode, based on the branch being in the CFG, identify a last branch in the CFG and set the precision mode of the instructions of the CFG to the basic BF mode, based on execution of the last branch being completed, set, to a high precision BF mode, a plurality instructions of use-definition chain, from among the instructions of the CFG, corresponding to a use-definition chain of a source operand of the last branch, and perform refining on remaining instructions of the CFG excluding the plurality of instructions of the use-definition chain.

Additional aspects may be set forth in part in the description which follows and, in part, may be apparent from the description, and/or may be learned by practice of the presented embodiments.

### BRIEF DESCRIPTION OF DRAWINGS

The above and other aspects, features, and advantages of certain embodiments of the present disclosure may be more apparent from the following description taken in conjunction with the accompanying drawings, in which:

FIG. 1 is a block diagram illustrating a system on chip (SoC) device, according to an embodiment;

FIG. 2 is a block diagram illustrating a graphics pipeline for image processing, according to an embodiment;

FIG. 3 is a block diagram illustrating a shader array, according to an embodiment;

FIG. 4 is a block diagram illustrating a shader engine, according to an embodiment;

FIG. 5A illustrates an example where the precision of instructions has been passively adjusted, according to a comparative example;

FIG. 5B is a table illustrating a result of benchmarking in a case where the precision of instructions has been passively adjusted, according to the table of FIG. 5A;

FIG. 6 is a timeline illustrating an example of context switching, according to a comparative example;

FIG. 7A is a table illustrating a result of benchmarking in which a BF16 mode has been forced, according to a comparative example;

FIG. 7B illustrates an example of a control flow graph (CFG) where image corruption occurs, according to a comparative example;

FIG. 7C illustrates another example of a CFG where image corruption occurs, according to a comparative example;

FIG. 8 is a flowchart illustrating an operating method of a shader engine, according to an embodiment;

FIG. 9 illustrates an example based on a use-definition chain with high precision, according to an embodiment;

FIG. 10 is a graph illustrating a result of benchmarking, according to an embodiment;

FIG. 11 is a timeline illustrating an example of an arithmetic logic unit (ALU) pipeline, according to an embodiment; and

FIG. 12 is a block diagram illustrating an electronic device, according to an embodiment.

### DETAILED DESCRIPTION

The following description with reference to the accompanying drawings is provided to assist in a comprehensive understanding of embodiments of the present disclosure defined by the claims and their equivalents. Various specific details are included to assist in understanding, but these details are considered to be exemplary only. Therefore, those of ordinary skill in the art may recognize that various changes and modifications of the embodiments described herein may be made without departing from the scope and spirit of the disclosure. In addition, descriptions of well-known functions and structures are omitted for clarity and conciseness.

With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wired), wirelessly, or via a third element.

Reference throughout the present disclosure to “one embodiment,” “an embodiment,” “an example embodiment,” or similar language may indicate that a particular feature, structure, or characteristic described in connection with the indicated embodiment is included in at least one embodiment of the present solution. Thus, the phrases “in one embodiment”, “in an embodiment,” “in an example embodiment,” and similar language throughout this disclosure may, but do not necessarily, all refer to the same embodiment. The embodiments described herein are example embodiments, and thus, the disclosure is not limited thereto and may be realized in various other forms.

It is to be understood that the specific order or hierarchy of blocks in the processes/flowcharts disclosed are an illustration of exemplary approaches. Based upon design preferences, it is understood that the specific order or hierarchy of blocks in the processes/flowcharts may be rearranged. Further, some blocks may be combined or omitted. The accompanying claims present elements of the various blocks in a sample order, and are not meant to be limited to the specific order or hierarchy presented.

The embodiments herein may be described and illustrated in terms of blocks, as shown in the drawings, which carry out a described function or functions. These blocks, which may be referred to herein as units or modules or the like, or by names such as device, logic, circuit, controller, counter, comparator, generator, converter, or the like, may be physically implemented by analog and/or digital circuits including one or more of a logic gate, an integrated circuit, a microprocessor, a microcontroller, a memory circuit, a passive electronic component, an active electronic component, an optical component, or the like.

In the present disclosure, the articles “a” and “an” are intended to include one or more items, and may be used interchangeably with “one or more.” Where only one item is intended, the term “one” or similar language is used. For example, the term “a controller” may refer to either a single controller or multiple controllers. When a controller is described as carrying out an operation and the controller is referred to perform an additional operation, the multiple operations may be executed by either a single controller or any one or a combination of multiple controllers.

Hereinafter, various embodiments of the present disclosure are described with reference to the accompanying drawings.

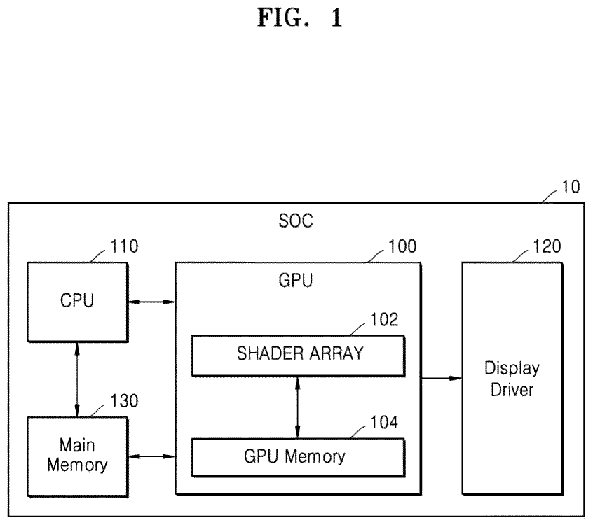

FIG. 1 is a block diagram illustrating a system on chip (SoC) device, according to an embodiment.

FIG. 1 illustrates an SoC 10 including a graphics processing unit (GPU) 100, according to an embodiment. The SoC 10 may include the GPU 100, a central processing unit (CPU) 110, a display driver 120, and a main memory 130.

According to embodiments, the SoC 10 may correspond to a computing device that may process and/or display two-dimensional (2D) or three-dimensional (3D) graphics data. For example, the SoC 10 may be implemented as a television (TV) (e.g., a digital TV, a smart TV, or the like), a personal computer (PC), a desktop computer, a laptop computer, a computer workstation, a tablet PC, a video game platform (or a video game console), a server, a portable electronic device, or the like. However, embodiments of the present disclosure are not limited thereto. For example, the portable electronic device may be implemented as, but not limited to, a mobile phone, a smartphone, a personal digital assistant (PDA), an enterprise digital assistant (EDA), a digital still camera, a digital video camera, a portable multimedia player (PMP), a personal navigation device (or portable navigation device) (PND), a mobile Internet device (MID), a wearable computer, an Internet of things (IoT) device, an Internet of everything (IoE) device, an electronic book (e-book or eBook), or the like.

According to an embodiment, the CPU 110 may be implemented as circuitry (e.g., processing circuitry) such as, but not limited to, an SoC or an integrated circuit (IC). The CPU 110 may include one or more processors. For example, the CPU 110 may include a combination of one or more processors, such as, but not limited to, a CPU, a GPU, a micro processing unit (MPU), an application processor (AP), a communication processor (CP), or the like. Each of the one or more processors may be implemented as a single core processor including one core and/or as one or more multicore processors including a plurality of cores (e.g., a homogeneous multi core and/or a heterogeneous multi core). In a case where the one or more processors are implemented as a multicore processor, each of the plurality of cores included in the multicore processor may include processor internal memory such as, but not limited to, cache memory, and on-chip memory, and common cache shared by the plurality of cores may be included in the multicore processor. Additionally, each of the plurality of cores (or part of the plurality of cores) included in the multicore processor may read and/or perform a program instruction for implementing the method independently or in a manner that all (or part) of the plurality of cores are associated.

According to an embodiment, the CPU 110 may control the overall operation of the SoC 10. For example, the CPU 110 may be and/or may include an operational device and may process a task. The CPU 110 may transfer, to the GPU 100, a request for drawing at least one object onto a display, based on a user input. To this end, the CPU 110 may include a plurality of cores. In an embodiment, the CPU 110 may receive a task processing request and/or a task from the outside. In response to the task processing request, the CPU 110 may allocate the received task to at least one of the plurality of cores and may perform scheduling for transferring the task to the allocated task. Subsequently, the plurality of cores may process the task received from the CPU 110.

The CPU 110 may process and/or execute programs and/or data stored in a memory. For example, the CPU 110 may execute programs stored in the main memory 130, and thus, may control functions of the elements included in the SoC 10. For example, applications executed by the CPU 110 may include graphics rendering instructions. The graphics rendering instructions may be associated with a graphics application programming interface (API). For example, the graphics API may include and/or be compatible with a variety of graphics libraries that may include at least one of Open Graphics Library (OpenGL®) API, OpenGL for embedded systems (OpenGL® ES) API, Microsoft™ DirectX API, renderscript API, Web Graphics Library (WebGL) API, OpenVG® API, Compute Unified Device Architecture (CUDA), or the like. The CPU 110 may transfer a graphics rendering command to the GPU 100 through a bus.

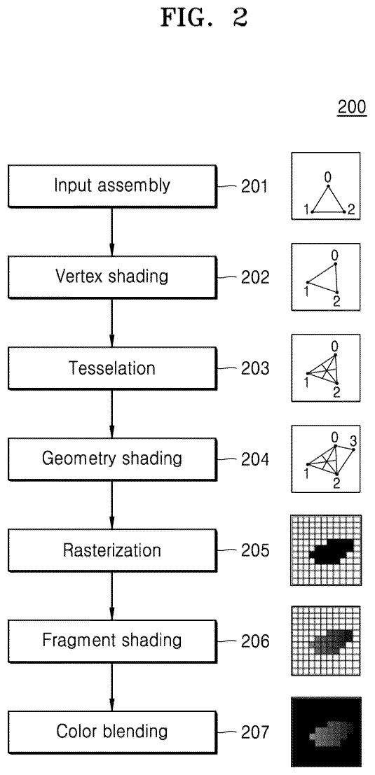

The GPU 100 may be and/or may include hardware that controls a graphic processing function of the SoC 10. The GPU 100 may be and/or may include a graphic dedicated processor configured to perform various versions and/or kinds of graphics pipelines such as, but not limited to, OpenGL, DirectX, CUDA, or the like, and may be implemented to execute a 3D graphics pipeline (e.g., a graphics pipeline 200 of FIG. 2) for rendering 3D objects of a 3D image to a 2D image on a display.

The GPU 100 may be controlled by a driver of the GPU 100 and/or an API executed in the CPU 110 driving an operating system (OS).

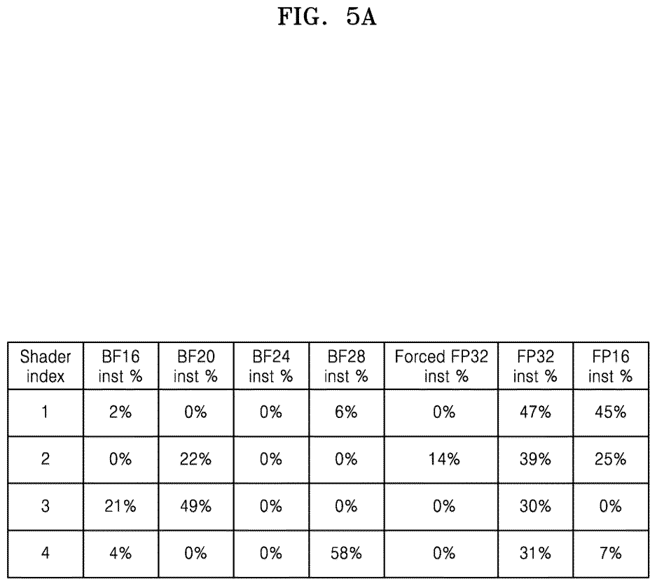

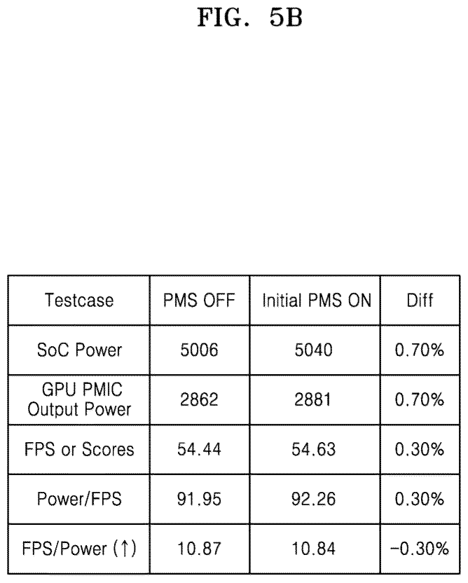

The GPU 100 may perform precision modulated shading (PMS) to variably change an operation mode. By performing PMS, a rendering quality of an image may be maintained by variably cutting a mantissa part for performing an efficient floating point operation. In addition, power consumption and/or an amount of memory use (e.g., memory footprint) may be reduced by decreasing the number of operations, when compared to related shading methods. Since a human eye may be limited in its ability to sense (distinguish) a relatively small color value difference and/or a relatively small depth value difference of a pixel, a degradation in image quality may be allow, and consequently, the number of operations may be decreased to a level at which the image quality difference is not sensed with the naked eyes. Thereby, performance may be improved when compared to related shading methods. However, according to a comparative example, even when a floating point operation is performed based on PMS, as illustrated in FIGS. 5A, 5B, 6, 7A, 7B, and 7C, a problem such as degradation in the ratio of power consumption to performance or the occurrence of image corruption may occur, and thus, there may exist a need for further improvements in graphic processing technology.

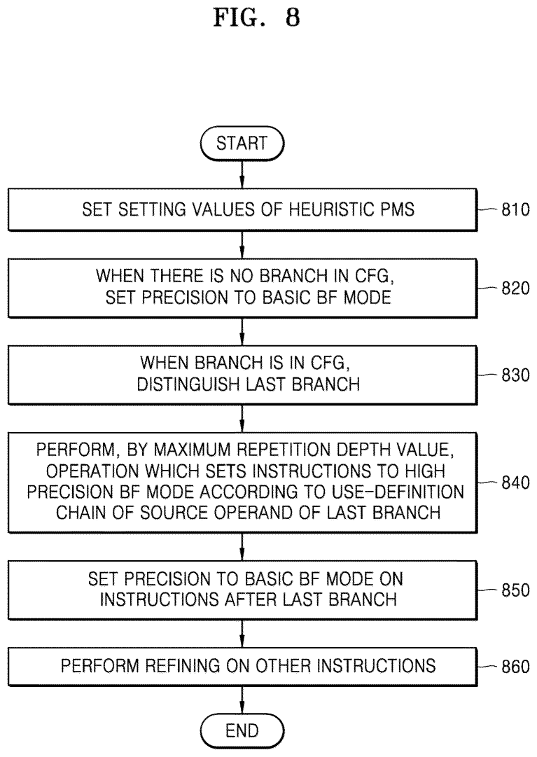

According to an embodiment, the GPU 100 may perform PMS based on a heuristic algorithm. The PMS based on a heuristic algorithm may be variously referred to as a heuristic PMS and/or an aggressive PMS. The heuristic PMS may refer to an algorithm that may set, to be high (e.g., a high precision mode), the precision of instructions associated with source operands of a branch from among instructions performed by a fragment shader and, may set, to be low (e.g., a low precision mode), the precision of instructions after a last branch (e.g., after completion of execution of instructions corresponding to the last branch). When based on the heuristic PMS, the GPU 100 may improve a ratio of power consumption to performance without image corruption, when compared to related shading methods. The heuristic PMS is further described with reference to FIGS. 8 to 10.

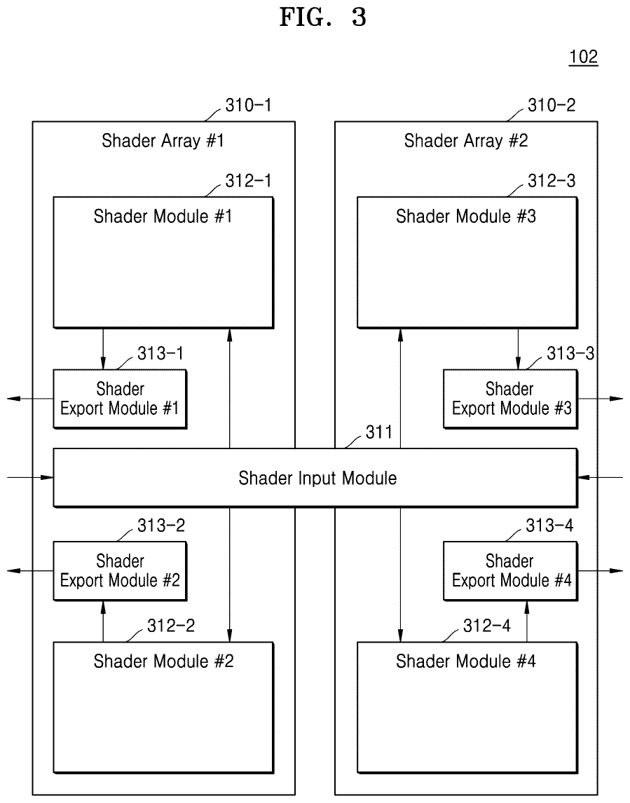

According to an embodiment, the shader array 102 may perform a graphics pipeline for immediate mode rendering (IMR) and/or tile-based rendering (TBR). As used herein, the term tile-based may denote that each frame of a moving image is divided into a plurality of tiles, and subsequently, rendering may be performed by tile units. A tile-based architecture may refer to a graphics rendering method that may be used in a mobile device (or an embedded device) having relatively-low performance (e.g., a tablet device) because the number of operations may be more reduced than a case that processes a frame by pixel units. A structure of the shader array 102 is further described with reference to FIG. 3.

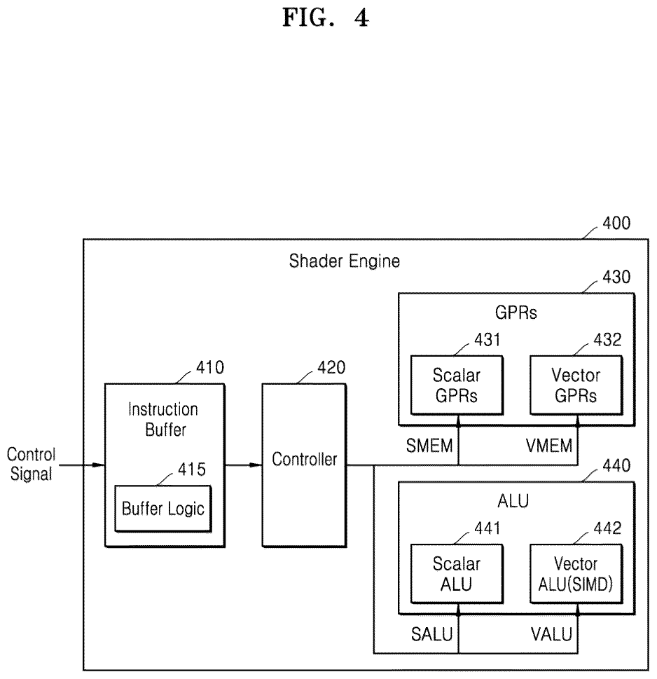

The shader array 102 may include a plurality of shader modules (e.g., a first shader module 312-1, a second shader module, a third shader module, and a fourth shader module 312-4 of FIG. 3). Each of the plurality of shader modules 312-1 to 312-4 may process and/or perform a stage of a graphics pipeline corresponding to a corresponding shader module among the plurality of shader modules 312-1 to 312-4. According to an embodiment, a shader engine (e.g., 400 of FIG. 4) may perform fragment shading 206 among a plurality of stages included in a graphics pipeline.

A GPU memory 104 may store graphic data processed by the GPU 100, or may store graphic data provided to the GPU 100. Alternatively, the GPU memory 104 may function as a working memory (e.g., a cache memory) of the GPU 100. For example, the GPU memory 104 may correspond to hardware that stores data (e.g., primitive information, vertex information, a tile list, a display list, frame information, or the like) on which processing is completed in the GPU 100, and/or provides data (e.g., data (e.g., component data) to be processed by a graphics pipeline) that is to be processed by the GPU 100 or an internal processor.

The display driver 120 may control a display device (e.g., a liquid crystal display (LCD), a light emitting diode (LED) display, an organic light emitting diode (OLED) display, a quantum-dot light emitting diode (QLED) display, a microelectromechanical systems (MEMS) display, or the like) to display an image frame rendered by the GPU 100.

The main memory 130 may include a memory array. The memory array included in the main memory 130 may be and/or may include random access memory (RAM) such as, but not limited to, dynamic random access memory (DRAM), static random access memory (SRAM), or the like, and/or may be and/or may include a device such as, but not limited to, read-only memory (ROM), electrically erasable programmable read-only memory (EEPROM), or the like.

The number and arrangement of components of the SoC 10 shown in FIG. 1 are provided as an example. In practice, there may be additional components, fewer components, different components, or differently arranged components than those shown in FIG. 1. Furthermore, two or more components shown in FIG. 1 may be implemented within a single component, or a single component shown in FIG. 1 may be implemented as multiple, distributed components. Alternatively or additionally, a set of (one or more) components shown in FIG. 1 may be integrated with each other, and/or may be implemented as an integrated circuit, as software, and/or a combination of circuits and software.

FIG. 2 is a block diagram illustrating a graphics pipeline for image processing, according to an embodiment.

Referring to FIG. 2, a graphics pipeline 200 representing a logical processing flow for performing a processing operation such as, but not limited to, image processing and/or graphic processing, by a device (e.g., SoC 10) that implements one or more aspects of the present disclosure is illustrated. In some embodiments, at least a portion of the graphics pipeline 200 may be performed by a device, which may include the GPU 100. Alternatively or additionally, another computing device (e.g., a UE, a server, a laptop, a smartphone, a camera, a wearable device, a smart device, a TV, a printer, an IoT device, or the like) that includes the GPU 100 may perform at least a portion of the graphics pipeline 200. For example, in some embodiments, the device and the other computing device may perform the graphics pipeline 200 in conjunction. That is, the device may perform a portion of the graphics pipeline 200 and a remaining portion of the graphics pipeline 200 may be performed by one or more other computing devices.

As shown in FIG. 2, the graphics pipeline 200 may include an input assembly stage 201, a vertex shading stage 202, a tessellation stage 203, a geometry shading stage 204, a rasterization stage 205, a fragment shading stage 206, and a color blending stage 207. However, embodiments of the present disclosure are not limited thereto, and some of the stages and/or operations described above may be omitted, and/or the graphics pipeline 200 may further include a stage that differs from the stages described above. Alternatively or additionally, one or more of the stages and/or operations described above may be processed and/or performed in a different order, as well as, sequentially and/or concurrently from each other.

The input assembly stage 201 may refer to a stage in the graphics pipeline 200 that may collect and/or organize raw vertex data from buffers, assembling the raw vertex data into primitives (e.g., points, lines, triangles, or the like) for shaders to process. The input assembly stage 201 may act as a first step of the graphics pipeline 200 by reading data from user-filled buffers and/or creating primitives for subsequent stages. In an embodiment, the input assembly stage 201 may attach system-generated values to the vertex data in order to potentially improve efficiency. That is, the input assembly stage 201 may prepare the data for shading by turning raw vertex information into structured geometric primitives, such as, but not limited to, points, lines, triangles, or the like.

The vertex shading stage 202 may refer to a stage in the graphics pipeline 200 that may transform the vertices (corner points) of a 3D model before drawing the model. For example, the vertex shading stage 202 may change at least one of a position, color, or texture coordinates of each vertex in order to create effects that may include, but not be limited to, animation, surface deformation, morphing, or the like. In an embodiment, the vertex shading stage 202 may not change the color of an individual pixel to be drawn on a display.

The tessellation stage 203 may refer to a stage in the graphics pipeline 200 that may convert low-detail subdivision surfaces into higher-detail primitives. For example, the tessellation stage 203 may tile (or break up) high-order surfaces into suitable structures for rendering. As another example, the tessellation stage 203 may subdivide a simple polygon mesh into smaller polygons, such as triangles, to create a more detailed surface. That is, the tessellation stage 203 may allow for more realistic and/or dynamic detail to be generated for displacement mapping and smoother silhouettes, for example, without performance limitations of using an overly complex base mesh.

The geometry shading stage 204 may refer to a stage in the graphics pipeline 200 that may generate and/or modify geometric primitives (e.g., points, lines, triangles, or the like). Unlike the vertex shading stage 202, which may operate on a single vertex, the geometry shading stage 204 may process a whole primitive (e.g., three (3) vertices for a triangle), enabling the geometry shading stage 204 to create new geometry, delete existing primitives, and/or change existing primitives.

The rasterization stage 205 may refer to a stage in the graphics pipeline 200 that may convert vector-based images, which may be defined by mathematical formulas, into a grid of pixels, such as, but not limited to, a raster, a bitmap, or the like. The rasterization stage 205 may render 3D scenes by applying primitives (e.g., triangles) onto the 3D scene one by one and determining which pixels are covered, thereby allowing for the creation of relatively complex visuals with shading and/or textures.

The fragment shading stage 206 may refer to a stage in the graphics pipeline 200 that may determine a final color of each pixel. For example, the fragment shading stage 206 may determine pixel-level details like lighting, texturing, color blending, or the like. In an embodiment, after a primitive (e.g., triangle) is rasterized into fragments (by the rasterization stage 205), the fragment shading stage 206 may process each rasterized fragment, which may represent a potential pixel, and may output a final color and/or depth value, which may be compared to a z-buffer to determine visibility of the pixel.

The color blending stage 207 may refer to a stage in the graphics pipeline 200 that may combine colors from different layers and/or objects to create a new color and/or a new visual effect. In an embodiment, the color blending stage 207 may perform blend modes to determine how the pixel colors of a foreground layer interact with those of the layers beneath the foreground layer.

Hereinafter, the fragment shading stage 206 of the graphics pipeline 200 is further described with reference to FIGS. 3, 4, 5A, 5B, 6, 7A, 7B, 7C, and 8 to 11.

FIG. 3 is a block diagram illustrating a shader array, according to an embodiment. The shader array 102 of FIG. 3 may include and/or may be similar in many respects to the shader array 102 of FIG. 1 and to the fragment shading stage 206 described above with reference to FIG. 2, and may include additional features not mentioned above. Consequently, repeated descriptions of the shader array 102 described above with reference to FIGS. 1 and 2 may be omitted for the sake of brevity.

Referring to FIG. 3, the shader array 102 of the GPU 100 may include a plurality of shader arrays (e.g., a first shader array 310-1 and a second shader array 310-2). The plurality of shader arrays 310-1 and 310-2 may share a shader input module 311. Each of the plurality of shader arrays 310-1 and 310-2 may include a plurality of shader modules and shader export modules respectively corresponding to the plurality of shader modules. For example, the first shader array 310-1 may include a first shader module 312-1 and a first shader export module 313-1 corresponding thereto, and a second shader module 312-2 and a second shader export module 313-2 corresponding thereto. The second shader array 310-2 may include a third shader module 312-3 and a third shader export module 313-3 corresponding thereto, and a fourth shader module 312-4 and a fourth shader export module 313-4 corresponding thereto. However, embodiments of the present disclosure are not limited thereto, and the first and second shader arrays 310-1 and 310-2 may be implemented in various structures. For example, the shader array 102 may include additional shader arrays (e.g., more than two (2)). As another example, each of the plurality of shader arrays 310-1 and 310-2 may include additional shader modules and/or shader export modules. Alternatively or additionally, at least one shader array may include a different number of shader modules and/or shader export modules from the remaining shader arrays of the plurality of shader arrays.

As used herein, a thread may refer to the smallest sequence of commands capable of being independently managed, and a thread block may refer to a group of threads capable of being executed in series and/or parallel. In addition, a wave or warp may refer to a group of thread blocks that may be simultaneously executed at a substantially similar time and/or the same time. As used herein, the wave may be and/or may include an arbitrary data/element (e.g., a vertex, a pixel, and primitive) processed by the GPU 100.

The shader input module 311 may allocate resources and/or may allocate waves to available wave slots of the plurality of shader modules 312-1 to 312-4 for graphic processing. For example, a controller (e.g., a controller 420 of FIG. 4) of each of the plurality of shader modules 312-1 to 312-4 may interleavedly schedule execution of instructions of waves and may control the execution of the instructions. For example, an operational module (e.g., an arithmetic logic unit (ALU) 440 of FIG. 4) may process a single command on multiple fragments of data (e.g., data corresponding to multiple threads). The operational module 440 may correspond to single instruction multiple data (SIMD). When processing of the wave ends, the result of the processing may be transferred to at least one of the plurality of shader export modules 313-1 to 313-4.

FIG. 4 is a block diagram illustrating a shader engine 400, according to an embodiment.

Referring to FIG. 4, the shader engine 400 may correspond to a hardware element that may perform fragment shading as described above with reference to the fragment shading stage 206 of FIG. 2. For example, the shader engine 400 may include and/or may be similar in many respects to each of the plurality of shader modules 312-1 to 312-4 described above with reference to FIG. 3, and may include additional features not mentioned above. That is, the shader engine 400 may correspond to the first shader module 312-1, the second shader module 312-2, the third shader module 312-3, or the fourth shader module 312-4 of FIG. 3. Consequently, repeated descriptions of the shader engine 400 described above with reference to FIGS. 2 and 3 may be omitted for the sake of brevity.

The shader engine 400 may include an instruction buffer 410, a controller 420, general-purpose registers (GPRs) 430, and an arithmetic logic unit (ALU) 440.

According to an embodiment, the instruction buffer 410 may include a plurality of buffers. Each of the plurality of buffers may store a per-wave instruction. For example, a first instruction buffer may store one or more instructions corresponding to a first wave, and a second instruction buffer may store one or more instructions corresponding to a second wave.

According to an embodiment, the instruction buffer 410 may include buffer logic 415. The buffer logic 415 may generate and/or execute a new instruction representing a precision mode change. That is, the buffer logic 415 may generate a new instruction instructing the controller 420 to change a precision mode. The new instruction may be, for example, an s_pms_mode_change instruction. According to an embodiment, the new instruction generated and executed by the buffer logic 415 may use a vector pipeline without using a scalar pipeline.

The s_pms_mode_change instruction may be executed simultaneously with a vector instruction (e.g., v_add). That is, the s_pms_mode_change instruction may instruct the changing of a precision mode on a vector instruction starting with an incoming vector instruction (e.g., v_mul) included in the same wave. For example, vector instructions received before the s_pms_mode_change instruction may perform an arithmetic operation in a precision mode based on a floating point (FP) mode, and vector instructions received with and/or after the s_pms_mode_change instruction may perform an arithmetic operation in a precision mode based on brain floating point (BP) mode. The precision mode may include, but not be limited to, at least one of an FP mode (e.g., FP16, FP32, or the like) or a BF mode (e.g., BF16, BF32, or the like). In an embodiment, the FP mode may have fewer bits representing an exponent than the BF mode and/or may have more bits representing a mantissa than the BF mode. For example, when the number of bits for expressing a real number is equal to each other (e.g., FP16 and BF16), the FP16 may include one (1) bit representing a sign, five (5) bits representing an exponent, and ten (10) bits representing a mantissa.

In an embodiment, a precision mode before execution of the s_pms_mode_change instruction may differ from a precision mode after execution of the s_pms_mode_change instruction. For example, vector instructions before the s_pms_mode_change instruction may perform an arithmetic operation in an FP32 mode, and vector instructions after the s_pms_mode_change instruction may perform an arithmetic operation in an BF16 mode. The FP32 mode may refer to a precision mode in which a real number is represented with a precision of floating point 32 bits (e.g., a sign of one (1) bit, an exponent of eight (8) bits, and a mantissa of 23 bits), and the BF16 mode may refer to a mode in which a real number is represented with a precision of 16 bits (e.g., a sign of one (1) bit, an exponent of eight (8) bits, and a mantissa of seven (7) bits).

When the number of bits used to represent an exponent is equal in two different precision modes (e.g., eight (8) bits used by the FP32 mode and the BF16 mode), a range of values capable of being represented by the two precision modes may be equal to each other. Alternatively or additionally, when the number of bits used to represent a mantissa is less in one of the precision modes (e.g., BF16 mode uses seven (7) bits for the mantissa that is less than the 23 bits used by the FP32 mode for the mantissa), the precision of the precision mode using less bits may be lower (e.g., the BF16 has a lower precision than the FP32 mode).

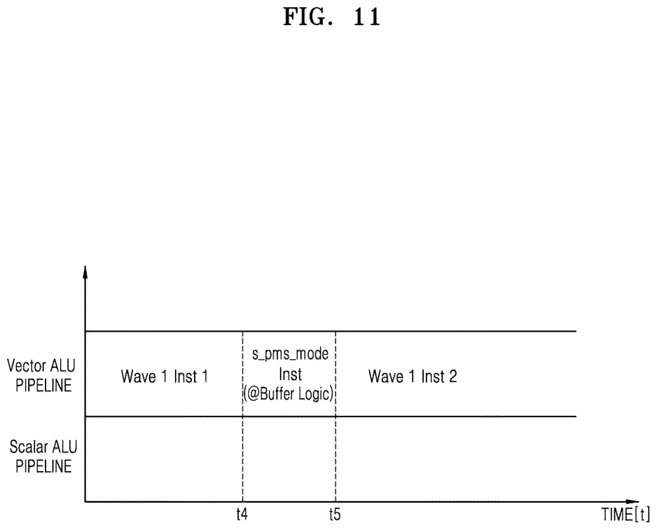

By reducing the precision of the calculations being performed, the number of operations (e.g., a computational load) may be decreased, and a ratio of power consumption to performance (e.g., a power efficiency) may be improved, when compared to related graphics processing units. The s_pms_mode_change instruction is further described with reference to FIG. 11.

The buffer logic 415 may not need to use a scalar pipeline to execute a scalar instruction of s_pms_mode_change within the buffer logic 415, and as such, the buffer logic 415 may not need to change a wave being processed in the vector pipeline by the use of the scalar pipeline. Consequently, data in an internal cache of a vector ALU 442 may be maintained as a result of the wave being processed in the vector pipeline not being changed. As the data of the internal cache of the vector ALU 442 is maintained, a cache miss may be prevented. Thereby, potentially decreasing latency and/or reducing power that may have been consumed by the processing triggered by the cache miss. For example, such processing may include, but not be limited to, the requesting of data and the loading of the data from the vector GPR 432 into the internal cache of the vector ALU 442 for a cache hit after the cache miss occurs, as further described with reference to FIGS. 5A, 5B, 6, and 11.

The controller 420 may interleave and schedule execution of waves and/or may control execution of instructions. As used herein, the controller 420 may be referred to as an instruction control circuit, an instruction scheduler, or the like. In an embodiment, the controller 420 may decode a wave and may convert an instruction of the decoded wave into an instruction (e.g., a machine language) of an assembly level to issue an operation code (OP) code. That is, the controller 420 may be and/or may include a control circuit that may decode an instruction for execution of the GPU 100 and may schedule the decoded instruction. For example, the controller 420 may issue a VALU instruction to the vector ALU 442, based on an instruction for a parallel arithmetic operation. The controller 420 may transfer input data VMEM for the VALU instruction to the vector GPRs 432. The controller 420 may issue an SALU instruction to a scalar ALU 441, based on an instruction for a single arithmetic operation (e.g., when the same value is needed in all threads like, for example, constant value processing). The controller 420 may transfer input data SMEM for the SALU instruction to the scalar GPRs 431. According to an embodiment, the controller 420 may simultaneously (e.g., at a substantially similar time and/or the same time) execute a VALU instruction and the s_pms_mode_change instruction. For example, in order to change a precision mode on a v_mul VALU instruction after a v_add VALU instruction, the controller 420 may execute the s_pms_mode_change instruction simultaneously with the v_add VALU instruction. The controller 420 may simultaneously execute the v_add VALU instruction and an s_pms_mode_change scalar instruction.

According to an embodiment, the ALU 440 may include the scalar ALU 441 for a single arithmetic operation and the vector ALU 442 for a parallel arithmetic operation. The scalar ALU 441 may perform a single arithmetic operation that may be applied to all threads in common. For example, a wave may consist of 32 threads generally, and the scalar ALU 441 may perform an arithmetic operation on only one scalar value. However, embodiments of the present disclosure are not limited thereto. The scalar ALU 441 may calculate and transfer the same value to all threads at a time. The vector ALU 442 may process various commands of a shader program such as, but not limited to, a loop index, a constant value operation, a conditional determination, or the like.

The vector ALU 442 may perform an arithmetic operation by applying a single instruction to pieces of data in parallel. For example, a wave may consist of 32 threads generally, and the vector ALU 442 may simultaneously perform the same instruction on each thread of a corresponding wave. The vector ALU 442 may process various commands of the shader program such as, but not limited to, an arithmetic operation, a logic operation, a condition branch, and texture result processing.

According to an embodiment, the GPR 430 may include a scalar GPR 431 and a vector GPR 432. The scalar GPR 431 may be and/or may include a register that may temporarily store an intermediate value for a single arithmetic operation performed by the scalar ALU 441. The vector GPR 432 may store an intermediate value of an arithmetic operation that has performed the same instruction on each thread of a corresponding wave. For example, the vector GPR 432 may consist of a plurality of banks (e.g., four banks), and each of the banks may be accessed in parallel.

FIG. 5A illustrates an example where the precision of instructions has been passively adjusted, according to a comparative example.

Referring to FIG. 5A, the table shows a result, obtained by experimentally changing a precision mode of an instruction without degradation in image quality capable of being distinguished with the naked eyes, and an instruction ratio of lowest precision capable of being selected for each shader. That is, when precision for each shader is set based on an instruction ratio based on the table, the number of operations may decrease, and image quality may be maintained.

For example, when the lowest precision is passively set within a range where image quality capable of being distinguished with the naked eyes is not degraded, 2% of all instructions of a first shader (share index 1) may be set to a BF16 mode, 6% of all instructions may be set to a BF28 mode, 47% of all instructions may be set to an FP32 mode, and 45% of all instructions may be set to an FP16 mode. As another example, 22% of all instructions of a second shader (share index 2) may be set to a BF20 mode, 14% of all instructions may be set to a forced FP32 mode, 39% of all instructions may be set to the FP32 mode, and 25% of all instructions may be set to the FP16 mode. As another example, 21% of all instructions of a third shader (share index 3) may be set to the BF16 mode, 49% of all instructions may be set to the BF20 mode, and 30% of all instructions may be set to the FP32 mode. As another example, 3% of all instructions of a fourth shader (share index 4) may be set to the BF16 mode, 60% of all instructions may be set to the BF20 mode, 30% of all instructions may be set to the FP32 mode, and 7% of all instructions may be set to the FP16 mode.

FIG. 5B is a table illustrating a result of benchmarking in a case where the precision of instructions has been passively adjusted, according to the table of FIG. 5A.

Referring to FIG. 5B, a result of benchmarking when instructions of each shader are set to the lowest precision is shown based on the table of FIG. 5A.

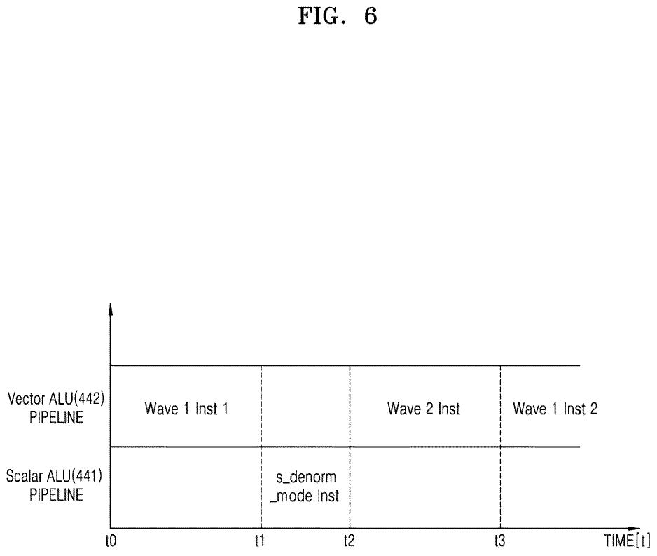

According to a comparative example, SoC power or output power of a power management integrated circuit (PMIC) of a GPU may increase. For example, it may be seen that the SoC power increases by 0.7% from 5,006 mW to 5,040 mW, and the output power of the PMIC of the GPU increases by 0.7% from 2,862 mW to 2,881 mW. According to FIG. 5A, because the instructions are set to the lowest precision, it may be confirmed that power consumption increases despite a case where power consumption has to be reduced. A frame per second (FPS) has increased by 0.3% from 54.44 fps to 54.63 fps. However, because the degree to which power consumption increases is greater than the degree to which the FPS is improved, it may be confirmed that the ratio of power consumption to performance is degraded as a result. For example, FPS/Power, which may be an indicator representing performance to power, has decreased by 0.3% from 10.87 fps/W to 10.84 fps/W. The reason that the ratio of power consumption to performance is oppositely degraded despite being set to the lowest precision is described with reference to FIG. 6.

FIG. 6 is a timeline illustrating an example of context switching, according to a comparative example.

Referring to FIG. 6, a flow of time for which context switching occurs is illustrated. The context switching may denote that a wave processed in an ALU pipeline is changed.

Referring to FIG. 5A, when instructions are passively set to the lowest precision without degradation in image quality capable of being distinguished with the naked eyes, mode switching may frequently occur. The mode switching may denote that a precision mode is changed in the middle of an instruction stream sequentially performing instructions. For example, n number of instructions may be performed in an FP32 mode (where n is a positive integer greater than one (1)), and then, one (1) instruction may be performed in a BF20 mode and may be changed to the FP32 mode. The context switching of FIG. 6 may occur whenever a precision mode is changed.

According to the comparative example, a vector instruction may be performed up to a second time t1 from a first time t0, based on a vector instruction. That is, in a vector ALU pipeline, a preceding instruction (Wave 1 Inst 1) of a first wave 1 may be processed from the first time t0 to the second time t1. Subsequently, the context switching may occur at the second time t1. For example, when the precision of the following instruction (Wave 1 Inst 2) differs from that of a preceding instruction (Wave 1 Inst 1), an s_denorm_mode instruction for changing precision from a previous first precision mode to a second precision mode may be executed. The s_denorm_mode instruction may be a scalar instruction, and thus, an SALU instruction may be issued. Based on minimization of an idle state of a vector ALU and a sequential characteristic of a pipeline, when the SALU instruction is issued, a vector pipeline may execute another wave. Therefore, an instruction (Wave 2 Inst) of another wave (Wave 2) may be processed in a vector ALU pipeline from a third time t2.

That is, even though the intent was to change a precision mode of a subsequent instruction within the same wave, however, it may be seen that the change has incurred an additional time for waiting for until an instruction from another wave occurs first.

Additionally, when the vector ALU pipeline processes the following instruction of an original wave (Wave 1) again, a problem of a cache miss and latency may occur. For example, because a fourth time t3 is the time at which an instruction of another wave (Wave 2) has been performed, an internal cache of the vector ALU 442 may store data corresponding to the other wave (Wave 2). Therefore, even when the following instruction of the original wave (Wave 1) is performed again at the fourth time t3, an intermediate value, which is a result of performance of the preceding instruction (Wave 1 Inst 1), is not in a cache, and as a result, a cache miss may occur. To address the cache miss, the vector ALU 442 may have to load an intermediate value of the preceding instruction (Wave 1 Inst 1) stored in the vector GPR 432. Therefore, latency consumed until loading data stored in the vector GPR 432 occurs, and power consumed in loading data may be added.

As described above, the ratio of power consumption to performance may be degraded despite the instructions being set to the lowest precision without degradation in image quality capable of being distinguished with the naked eyes due to the context switching that may occur. That is, the context switching may cause a time delay for waiting for until a processing time of another wave, additional latency caused by a cache miss of the vector ALU 442, as well as, additional power consumption, resulting in the ratio of power consumption to performance (FPS/Power) of FIG. 5B being degraded.

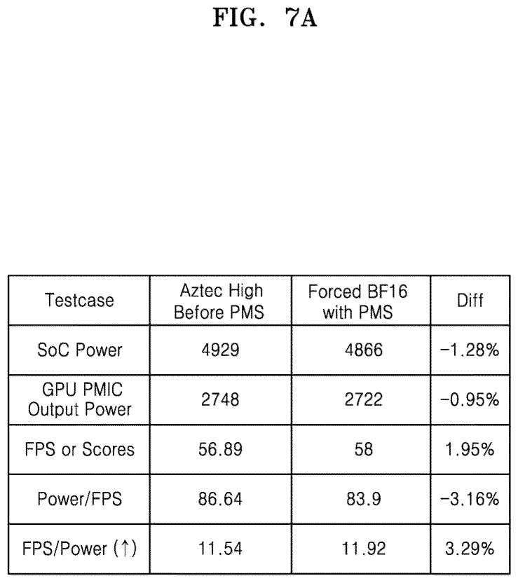

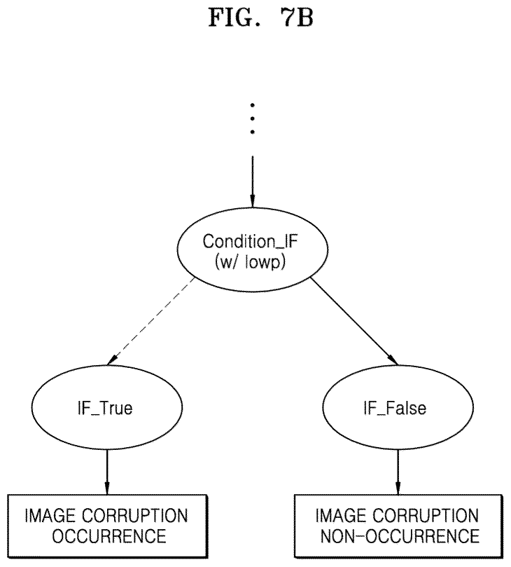

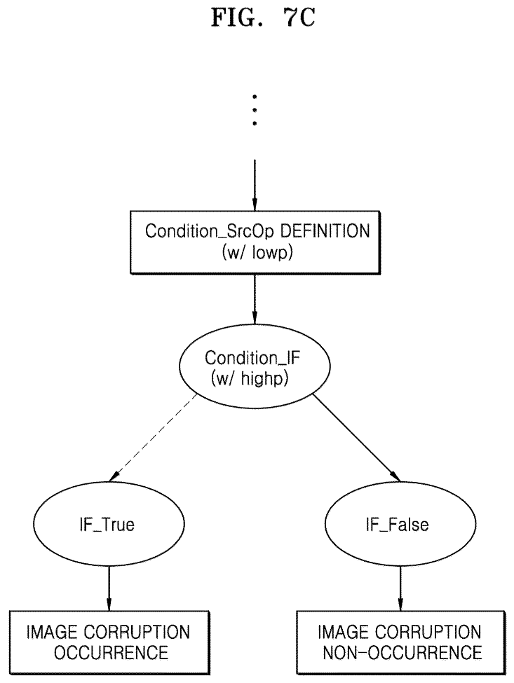

FIG. 7A is a table illustrating a result of benchmarking in which the BF16 mode has been forced, according to a comparative example.

Referring to FIG. 7A, in each shader, a BF mode may be forcibly changed to a BF16 mode. For example, referring to FIG. 7A, in conjunction with FIG. 5A, in a first shader (shader index 1), the 6% of instructions capable of being set to a BF28 mode from among all instructions may be forcibly changed to the BF16 mode, and thus, the instructions set to the BF16 mode may be 8% of all instructions for the first shader. In a second shader (shader index 2), the 22% of instructions capable of being set to a BF20 mode from among all instructions may be forcibly changed to the BF16 mode, and thus, the instructions set to the BF16 mode may be 22% of all instructions for the second shader. In a third shader (shader index 3), the 49% of instructions capable of being set to the BF20 mode from among all instructions may be forcibly changed to the BF16 mode, and thus, the instructions set to the BF16 mode may be 70% of all instructions for the third shader. In a fourth shader (shader index 4), the 58% of instructions capable of being set to the BF28 mode from among all instructions may be forcibly changed to the BF16 mode, and thus, the instructions set to the BF16 mode may be 62% of all instructions for the fourth shader.

According to the comparative example, because the BF mode is forcibly changed to the BF16 mode, context switching, according to FIG. 6, may be reduced. Therefore, SoC power and/or output power of a PMIC of a GPU may decrease. For example, as shown in FIG. 7A, it may be seen that the SoC power decreases by 1.28% from 4,929 mW to 4,866 mW, and the output power of the PMIC of the GPU decreases by 0.95% from 2,748mW to 2,722 mW. An FPS has increased by 1.95% from 56.89 fps to 58 fps. Because power consumption decreases, and the FPS is improved, FPS/Power, which is an indicator representing performance to power, may be improved by 3.29% from 11.54 fps/W to 11.92 fps/W. As a result of forcibly changing to the BF16 mode, the ratio of power consumption to performance may be improved, however, image corruption may occur. Image corruption is further described with reference to FIGS. 7B and 7C.

FIG. 7B illustrates an example of a control flow graph (CFG) where image corruption occurs, according to a comparative example.

Referring to FIGS. 7B and 7C, a CFG illustrating examples of image corruption may be described. The CFG may show an instruction set and a flow possible in execution by using a graph of a node form. FIG. 7B illustrates a problem that may occur when the precision of a branch is set to be low. FIG. 7C illustrates a problem that may occur when precision is set to be low in an instruction before a branch.

Referring to FIG. 7B, each shader (e.g., a shader engine 400) may perform a branch instruction. For example, a conditional instruction may compare source operands and may change a branch, based on a binary result of the conditional (e.g., true or “1” or false or “0”). For example, according to FIG. 7A, all instructions capable of being set to a BF mode may be forcibly changed to a BF16 mode and may determine whether a condition is true or false, based on low precision. Therefore, in a case that cuts (reduces) and determines mantissa parts of the source operands according to the BF16 mode, a flow, which has to proceed to be false, may proceed to be true, or a flow, which has to proceed to be true, may proceed to be false.

According to the comparative example, in a case that determines a condition without cutting the mantissa parts of the source operands, image corruption may not occur by proceeding to be false. In a case that cuts the mantissa parts of the source operands and determines a condition, image corruption may occur by proceeding to be true. For example, a shader may compare conditions by performing calculation with low precision despite a case that has to proceed to be false in a conditional statement, and thus, may proceed to be true, thereby discarding a part that may need to be calculated. Alternatively, the shader may abnormally determine an early-return condition to quickly return, and thus, a color and/or a depth value of a pixel may be differently calculated.

FIG. 7C illustrates another example of a CFG where image corruption occurs, according to a comparative example.

Referring to FIG. 7C, a CFG illustrating an example of image corruption may be described. FIG. 7C illustrates a problem that may occur when precision is set to be low in an instruction before a branch.

Each shader (e.g., a shader engine 400) may perform a branch instruction. The conditional instruction may compare source operands and may change a branch, based on true or false. Unlike FIG. 7B, a precision mode of a conditional statement may be set to be high (w/highp) so as to prevent a case that lowers the precision mode of the conditional statement to proceed to an abnormal branch. For example, the precision mode of the conditional statement may be an FP32 mode. In a case that compares source operands that are comparison targets of the conditional statement, the shader may cut (truncate) a mantissa part less than a BF16 mode to perform the determination. Even if the conditional instruction truncates the mantissa less than in BF16 mode, the shader may still proceed to an abnormal (or false) branch.

For example, there may be instructions that may define the source operands before the conditional instruction. According to FIG. 7A, the instructions that define the source operands may be still performed in a low precision mode. That is, because the source operand is calculated with low precision before the conditional instruction, a source operand value may include an error. Therefore, the shader may compare conditions according to a source operand abnormally calculated in a previous instruction despite a case that has to proceed to be false in the conditional statement, and thus, may proceed to be true, thereby discarding a part that is to be calculated. Alternatively, the shader may abnormally determine an early-return condition to quickly return, and thus, a color and/or a depth value of a pixel may be differently calculated.

FIG. 8 is a flowchart illustrating an operating method of the shader engine 400, according to an embodiment.

Referring to FIG. 8, in operation S810, the shader engine 400 may set setting values of heuristic PMS. The setting values of the heuristic PMS may include setting at least one of a maximum repetition depth value, a minimum setting threshold value, a basic BF mode value, a high precision BF mode value, or the lie.

The maximum repetition depth value may represent the number of repetitions of a case that sets to a high precision BF mode value according to a use-definition chain, based on a source operand of a last branch. For example, a source operand A of the last branch may be defined n times before the last branch. Also, precision may be set to a high precision BF mode on all of n number of instructions defining the source operand A, or may be set to a high precision BF mode on only m (where m is a positive integer less than n) number of instructions. As used herein, m may represent a maximum repetition depth value and may be heuristically determined.

The minimum setting threshold value may be a value that may be set for preventing switching of a BF mode that may be very low. For example, in a case that performs fewer instructions than the minimum setting threshold value after mode switching, a precision mode may be set to be maintained without being changed. The minimum setting threshold value may be heuristically determined.

The basic BF mode may refer to a precision mode that is to be set fundamentally. For example, the basic BF mode may be BF20. The high precision BF mode may denote a precision mode that is to be set on instructions sensitive to precision. For example, the high precision BF mode may be BF28. The basic BF mode and the high precision BF mode may be heuristically determined.

In operation S820, when there is no branch in a shader CFG, the shader engine 400 may set precision to the basic BF mode. When there is no branch in a CFG, the shader engine 400 may set precision to the basic BF mode on all blocks of the CFG. For example, the shader engine 400 may set instructions instead of a branch to operate in the BF20 mode.

In operation S830, when a branch is in the CFG, the shader engine 400 may distinguish a last branch. For example, a WHILE statement and an IF statement may be sequentially provided in the CFG. The shader engine 400 may execute a GetLastConditionalInstruction() instruction to distinguish a branch disposed in the last portion among branches of the CFG.

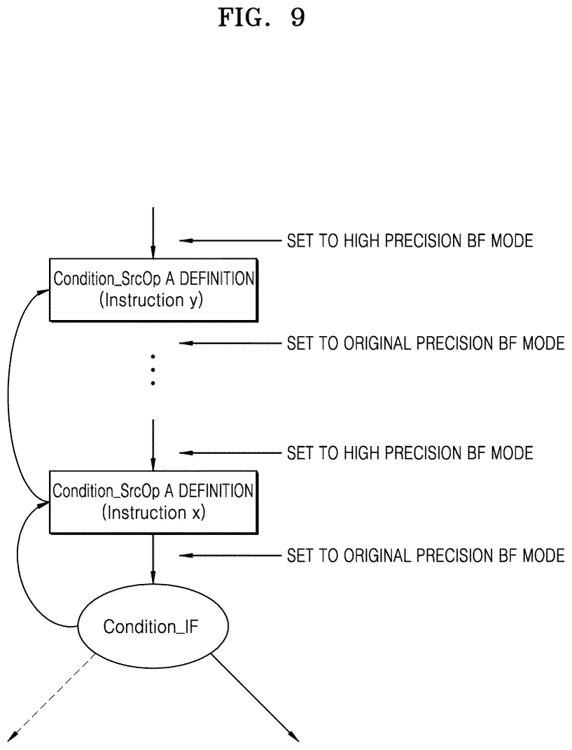

In operation S840, the shader engine 400 may perform, by a maximum repetition depth value, an operation that sets instructions to a high precision BF mode according to a use-definition chain of a source operand of the last branch. For example, referring to FIG. 8 in conjunction with FIG. 9, the shader engine 400 may distinguish an instruction x that has latest defined a source operand A of the last branch, based on the use-definition chain. The shader engine 400 may set the precision of the instruction x to a BF28 mode, based on a high precision BF mode value. Subsequently, the maximum repetition depth value may decrease by one (1). The shader engine 400 may calculate the instruction x based on the high precision BF mode value, and then, may recover the BF mode to an original state again. The shader engine 400 may distinguish an instruction y where a source operand A of the instruction x is defined before the instruction x, based on the use-definition chain. The shader engine 400 may set the precision of the instruction y to the BF28 mode, based on the high precision BF mode value. Subsequently, the maximum repetition depth value may decrease by one (1). The shader engine 400 may calculate the instruction y based on the high precision BF mode value, and then, may recover the BF mode to an original state again. An operation that sets an instruction to high precision while reversely tracking the instruction may be repeated by the maximum repetition depth value, based on the use-definition chain. Accordingly, calculation may be performed on all instructions defining the source operand of the last branch with high precision, thereby preventing a case that proceeds to an abnormal branch because a source operand value is incorrect.

In operation S850, the shader engine 400 may set precision to the basic BF mode on instructions after the last branch. In a case that proceeds to a correct branch in the last branch, the shader engine 400 may set precision to the basic BF mode on instructions subsequent thereto. Instructions after the last branch may be set to the basic BF mode, and thus, the number of operations may be reduced, and performance may be improved.

In operation S860, the shader engine 400 may perform refining on the other instructions. The refining may correspond to an operation of adjusting a precision mode of a branch and the other instructions, except instructions of a use-definition chain, of a source operand of the branch. For example, the shader engine 400 may adjust the precision mode of the other instructions to prevent frequent mode switching, based on the minimum setting threshold value. For example, the shader engine 400 may compare a basic precision mode with a precision mode that is set on an arbitrary instruction of the CFG. Instructions where the set precision mode is higher than the basic precision mode may be continued, and when the number of continued instructions is more than the minimum setting threshold value, the shader engine 400 may set a precision mode of an instruction to the basic precision mode. Instructions where the currently set precision mode is higher than the basic precision mode may be continued, and when the number of continued instructions is less than the minimum setting threshold value, the shader engine 400 may maintain the set precision mode, thereby potentially preventing frequent mode switching.

According to various embodiments, the refining of operation S860 may be omitted. For example, the refining may be applied exclusively on an embodiment that generates an s_pms_mode_change instruction. In a case where the refining is performed, an operation of generating the s_pms_mode_change instruction may be skipped, and in a case that generates the s_pms_mode_change instruction, the refining may be skipped.

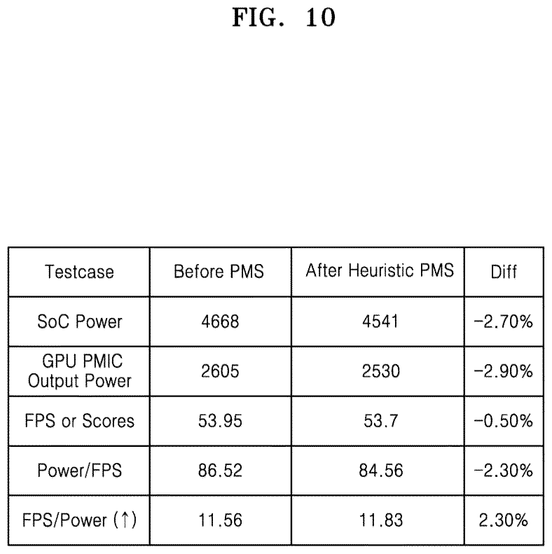

FIG. 10 is a graph illustrating a result of benchmarking, according to an embodiment.

Referring to FIG. 10, each shader may set a precision mode of instructions, based on the heuristic PMS of FIG. 8. For example, a branch of a CFG and instructions of a use-definition chain of a source operand of the branch may be set to a high precision BF mode. Instructions after a last branch may be set to a low precision BF mode.

According to an embodiment, the precision of instructions may be set based on the heuristic PMS, and thus, SoC power or output power of a PMIC of a GPU may decrease. For example, as shown in FIG. 10, it may be seen that the SoC power decreases by 2.7% from 4,668 mW to 4,541 mW, and the output power of the PMIC of the GPU decreases by 2.9% from 2,605 mW to 2,530 mW. An FPS has decreased by 0.5% from 53.95 fps to 53.7 fps. Power consumption has decreased, and the FPS has partially decreased, but a decrease width of power consumption is very large, and thus, FPS/Power, which is an indicator representing performance to power, is improved by 2.3% from 11.56 fps/W to 11.83 fps/W. Referring to FIG. 10 in conjunction with FIG. 7A, in a case where precision is forcibly changed to a BF16 mode, the ratio of power consumption to performance has been improved by 3.29%, and thus, an improvement width of the ratio of power consumption to performance has partially decreased compared to a case where precision is forcibly changed to the BF16 mode, but image corruption in the BF16 mode does not occur, and accordingly, according to an embodiment, by applying the heuristic PMS, image corruption may be prevented, and performance may be improved.

FIG. 11 is a timeline illustrating an example of an ALU pipeline, according to an embodiment.

Referring to FIG. 11, in an embodiment, a change in an ALU pipeline over time with respect to changing of a precision mode is illustrated.

Referring to FIG. 4, the buffer logic 415, according to an embodiment, may generate and execute a new instruction representing a precision mode change. The new instruction may be, for example, an s_pms_mode_change instruction. According to an embodiment, the new instruction generated and executed by the buffer logic 415 may use a vector pipeline without using a scalar pipeline.

According to an embodiment, a vector instruction may be performed up to a fifth time t4, based on a first precision mode. That is, in a vector ALU pipeline, a preceding instruction (Wave 1 Inst 1) of a first wave 1 may be processed up to the fifth time t4. In a case that has to change a precision mode of the following instruction (Wave 1 Inst 2), the buffer logic 415 may generate an s_pms_mode_change instruction for instructing the case and may execute the s_pms_mode_change instruction along with the preceding instruction (Wave 1 Inst 1). The s_pms_mode_change instruction may be previously generated and executed by the buffer logic 415, and thus, may not be processed by the scalar ALU 441. Accordingly, from the fifth time t4 time to a sixth time t5, a wave of the vector ALU pipeline may not be changed and may be maintained to be the same wave (Wave 1). Because the wave of the vector ALU pipeline is not changed, a cache miss may not occur, and additional power consumption and latency caused by the cache miss may be prevented.

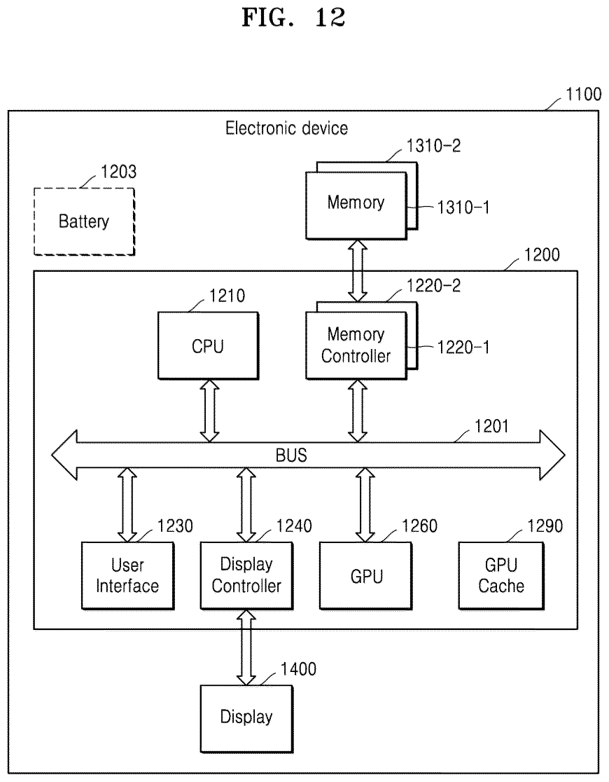

FIG. 12 is a block diagram illustrating an electronic device 1100, according to an embodiment.

Referring to FIG. 12, the electronic device 1100 may be implemented as a TV (e.g., a digital TV or a smart TV), a PC, a desktop computer, a laptop computer, a computer workstation, a tablet PC, a video game platform (or a video game console), a server, a portable electronic device, or the like. However, embodiments of the present disclosure are not limited thereto.

The portable electronic device may be implemented, for example, as a mobile phone, a smartphone, a PDA, an EDA, a digital still camera, a digital video camera, a PMP, a PND, an MID, a wearable computer, an IoT device, an IoE device, an e-book, or the like. However, embodiments of the present disclosure are not limited thereto.

The electronic device 1100 may include various devices that may process and/or display 2D and/or 3D graphics data. The electronic device 1100 may include an SoC 1200, at least one memory (e.g., a first memory 1310-1 and a second memory 1310-2), and a display 1400.

The SoC 1200 may perform a function of a host of the electronic device 1100. The SoC 1200 may perform overall control an operation of the electronic device 1100. For example, the SoC 1200 may be replaced with an integrated circuit (IC), an application processor (AP), or a mobile AP, which may control the shader module 321 (e.g., a hardware element) to load, at a multi-cycle, input data that may need to be processed by a graphics pipeline, when an address of the input data to be processed by the graphics pipeline does not satisfy a minimum sorting condition. The SoC 1200 of FIG. 12 may include and/or may be similar in many respects to the SoC 10 described above with reference to FIG. 1, and may include additional features not mentioned above. Consequently, repeated descriptions of the SoC 1200 described above with reference to FIG. 1 may be omitted for the sake of brevity.

A CPU 1210, at least one memory controller (e.g., a first memory controller 1220-1 and a second memory controller 1220-2), a user interface 1230, a display controller 1240, and a graphics processing unit (GPU) 1260 may communicate with each other through a bus 1201. The CPU 1210 of FIG. 12 may include and/or may be similar in many respects to the CPU 110 described above with reference to FIG. 1, and may include additional features not mentioned above. Consequently, repeated descriptions of the CPU 1210 described above with reference to FIG. 1 may be omitted for the sake of brevity.

For example, the bus 1201 may be implemented as peripheral component interconnect (PCI) bus, PCI Express bus, advanced high performance bus (AMBA), advanced high performance bus (AHB), advanced peripheral bus (APB), an Advanced eXtensible Interface (AXI) bus, or a combination thereof.

The CPU 1210 may control an operation of the SoC 1200. According to an embodiment, the CPU 1210 may determine (e.g., calculate and/or measure) at least one of one or more attributes (or characteristics) of the electronic device 1100, may select one address from among a plurality of addresses in a plurality of memory regions included in the first memory 1310-1 storing a plurality of models that may be ready, based on a result of the determination (a calculation and/or a measurement), and may transfer the selected address to the GPU 1260. The GPU 1260 of FIG. 12 may include and/or may be similar in many respects to the GPU 100 described above with reference to FIG. 1, and may include additional features not mentioned above. Consequently, repeated descriptions of the GPU 1260 described above with reference to FIG. 1 may be omitted for the sake of brevity.

When the electronic device 1100 is a portable electronic device, the electronic device 1100 may include a battery 1203 for supplying power into the electronic device 1100.

A user may provide an input to the SoC 1200 so that the CPU 1210 executes one or more applications (e.g., software applications).

The applications executed by the CPU 1210 may include an OS, a word processor application, a media player application, a video game application, a graphical user interface (GUI) application, or the like.

The user may input an input to the SoC 1200 through an input device connected to the user interface 1230. For example, the input device may be implemented as, but not limited to, a keyboard, a mouse, a microphone, or a touch pad.

Also, the applications executed by the CPU 110 may include graphics rendering instructions. The graphics rendering instructions may be associated with a graphics API.

The graphics API may refer to at least one of OpenGL® API, OpenGL® ES API, DirectX API, renderscript API, WebGL API, openVG® API, or the like.

To process the graphics rendering instructions, the CPU 1210 may transfer a graphics rendering command to the GPU 1260 through the bus 1201. Therefore, the GPU 1260 may process (or render) graphics data in response to the graphics rendering command.

The graphics data may include points, lines, triangles, quadrilateral, patches, and/or primitives. Also, the graphics data may include line segments, elliptical arcs, quadratic Bezier curves, and/or cubic Bezier curves.

In response to a read request from the CPU 1210 or the GPU 1260, the at least one memory controller 1220-1 and 1220-2 may read data (e.g., graphics data) stored in the at least one memory 1310-1 and 1310-2 and may transfer the read data (e.g., graphics data) to a corresponding element (e.g., the CPU 1210, the display controller 1240, or the GPU 1260).

In response to a write request from the CPU 1210 or the GPU 1260, the at least one memory controller 1220-1 and 1220-2 may write data (e.g., graphics data), output from a corresponding element (e.g., the CPU 1210, the user interface 1230, or the display controller 1240), in the at least one memory 1310-1 and 1310-2. The at least one memory 1310-1 and 1310-2 of FIG. 12 may include and/or may be similar in many respects to the main memory 130 described above with reference to FIG. 1, and may include additional features not mentioned above. Consequently, repeated descriptions of the at least one memory 1310-1 and 1310-2 described above with reference to FIG. 1 may be omitted for the sake of brevity.

For convenience of description, FIG. 12 illustrates that the at least one memory controller 1220-1 and 1220-2 are split from the CPU 1210 or the GPU 1260. However, embodiments of the present disclosure are not limited thereto, and the at least one memory controller 1220-1 and 1220-2 may be implemented in the CPU 1210, the GPU 1260, or the at least one memory 1310-1 and 1310-2.

According to an embodiment, when the first memory 1310-1 is implemented as a volatile memory, and the second memory 1310-2 is implemented as a non-volatile memory, the first memory controller 1220-1 may be implemented as a memory controller that may communicate with the first memory 1310-1, and the second memory controller 1220-2 may be implemented as a memory controller that may communicate with the second memory 1310-2.

For example, the volatile memory may be implemented as at least one of RAM, SRAM, DRAM, synchronous DRAM (SDRAM), thyristor RAM (T-RAM), zero capacitor RAM (Z-RAM), or twin transistor RAM (TTRAM). However, embodiments of the present disclosure are not limited thereto.

The non-volatile memory may be implemented as at least one of EEPROM, flash memory, magnetic RAM (MRAM), spin-transfer torque MRAM, ferroelectric RAM (FeRAM), phase change RAM (PRAM), or resistive RAM (RRAM). However, embodiments of the present disclosure are not limited thereto.

Alternatively or additionally, the non-volatile memory may be implemented as a multimedia card (MMC), an embedded MMC (eMMC), a universal flash storage (UFS), a solid state drive (SSD), or a USB flash drive. However, embodiments of the present disclosure are not limited thereto.

The at least one memory controller 1220-1 and 1220-2 may store a program (or an application) or instructions executable by the CPU 1210. Alternatively or additionally, the at least one memory controller 1220-1 and 1220-2 may store data that is to be used in a program executed by the CPU 1210.

In an embodiment, the at least one memory controller 1220-1 and 1220-2 may store a user application and graphics data associated with the user application. Alternatively or additionally, the at least one memory controller 1220-1 and 1220-2 may store data (and/or information) that may be to be used by the elements included in the SoC 1200 and/or may be generated by the elements.

The at least one memory controller 1220-1 and 1220-2 may store data that may be to be used in an operation of the GPU 1260 and/or data generated by the operation of the GPU 1260. The at least one memory controller 1220-1 and 1220-2 may store command streams for processing of the GPU 1260.

The display controller 1240 may transfer, to the display 1400, data obtained through processing by the CPU 1210 or data (e.g., graphics data) obtained through processing by the GPU 1260. The display controller 1240 of FIG. 12 may include and/or may be similar in many respects to the display driver 120 described above with reference to FIG. 1, and may include additional features not mentioned above. Consequently, repeated descriptions of the display controller 1240 described above with reference to FIG. 1 may be omitted for the sake of brevity.

The display 1400 may be implemented, for example, as at least one of a monitor, a TV monitor, a projection device, a thin film transistor-liquid crystal display (TFT-LCD), a light-emitting diode (LED) display, an organic LED (OLED) display, an active-matrix OLED (AMOLED) display, a flexible display, or the like. However, embodiments of the present disclosure are not limited thereto.

According to an embodiment, the display 1400 may be integrated (or embedded) in the electronic device 1100. For example, the display 1400 may be and/or may include a screen of a portable electronic device and may be a stand-alone device that may be connected to the electronic device 1100 through a wireless communication link and/or a wired communication link.

According to an embodiment, the display 1400 may be a computer monitor that may be connected to a PC through a cable and/or a wired link.

The GPU 1260 may receive commands output from the CPU 1210 and may execute the received commands. The commands executed by the GPU 1260 may include a graphics command, a memory transfer command, a kernel execution command, a tessellation command, a texturing command, or the like.

The GPU 1260 may perform graphics operations for rendering graphics data.

When an application executed by the CPU 1210 needs to perform graphics processing, the CPU 1210 may transfer graphics data to the GPU 1260 so as to render the graphics data in the display 1400 and may transfer a graphics command to the GPU 1260.

The graphics command may include the tessellation command and/or the texturing command. The graphics data may include vertex data, texture data, surface data, or the like.

The surface may include at least one of a parametric surface, a subdivision surface, a triangle mesh, or a curve. However, embodiments of the present disclosure are not limited thereto.

According to embodiments, the CPU 1210 may transfer the graphics command and the graphics data to the GPU 1260. According to other embodiments, when the CPU 1210 respectively writes the graphics command and the graphics data in the at least one memory 1310-1 and 1310-2, the GPU 1260 may read the graphics command and the graphics data respectively written in the at least one memory 1310-1 and 1310-2.

The GPU 1260 may directly access a GPU cache 1290. Therefore, the GPU 1260 may write the graphics data in the GPU cache 1290, and/or may read the graphics data from the GPU cache 1290, without passing through the bus 1201. The GPU cache 1290 may be an example of a GPU memory that may be accessible by the GPU 1260.

In FIG. 12, the GPU 1260 and the GPU cache 1290 may be split from each other. However, according to various embodiments, the GPU 1260 may include the GPU cache 1290. For example, the GPU cache 1290 may be implemented as DRAM or SRAM. However, embodiments of the present disclosure are not limited thereto.

Hereinabove, exemplary embodiments have been described in the drawings and the specification. Embodiments have been described by using the terms described herein, but this has been merely used for describing the disclosure and has not been used for limiting a meaning or limiting the scope of the disclosure defined in the following claims. Therefore, it may be understood by those of ordinary skill in the art that various modifications and other equivalent embodiments may be implemented from the disclosure. Accordingly, the spirit and scope of the disclosure may be defined based on the spirit and scope of the following claims.

While the disclosure has been particularly shown and described with reference to embodiments thereof, it is to be understood that various changes in form and details may be made therein without departing from the spirit and scope of the following claims.

What is claimed is:

1. A shader engine device for performing shading, the shader engine device comprising:
an instruction buffer configured to store instructions;
a controller configured to schedule execution of the instructions;
an arithmetic logic unit (ALU) configured to perform a graphics operation; and
a general-purpose register configured to store an intermediate value of the graphics operation,
wherein the controller is further configured to:
change a precision mode of the instructions to a high precision mode, based on heuristic precision modulated shading (PMS), the instructions being associated with a source operand of a branch.

2. The shader engine device of claim 1, wherein the controller is further configured to:
identify, from among the instructions, a last branch in a control flow graph (CFG), and
set the precision mode of the instructions to a low precision mode, based on execution of the last branch being completed.

3. The shader engine device of claim 1, wherein the controller is further configured to:
identify, from among the instructions, a last branch in a control flow graph (CFG),
determine a use-definition chain of the source operand of the last branch, and
set, to the high precision mode, the precision mode of a plurality of instructions of the use-definition chain of the source operand.

4. The shader engine device of claim 3, wherein the controller is further configured to:
set, to the high precision mode, the precision mode of one or more instructions corresponding to a maximum repetition depth value from among the plurality of instructions of the use-definition chain of the source operand.

5. The shader engine device of claim 1, wherein the controller is further configured to:
determine a maximum repetition depth value of the heuristic PMS based on at least one of a use-definition chain, a basic brain floating point (BF) mode value, or a high precision BF mode value, the maximum repetition depth value indicating a number of instructions having to be set to the high precision mode, and
determine a minimum setting threshold value of the heuristic PMS, the minimum setting threshold value indicating a minimum number of instructions provided between precision mode switching.

6. The shader engine device of claim 1, wherein the ALU comprises:
a scalar ALU configured to perform a scalar operation; and
a vector ALU configured to perform a vector operation,
wherein the general-purpose register comprises:
a general-purpose scalar register configured to store a scalar value of the scalar operation; and
a general-purpose vector register configured to store a vector value of the vector operation.

7. The shader engine device of claim 1, wherein the instruction buffer further comprises:
a buffer logic configured to generate a scalar instruction instructing a changing of the precision mode.

8. The shader engine device of claim 1, wherein the controller is further configured to:
perform the heuristic PMS by performing fragment shading in a graphics pipeline.

9. An operating method of a shader engine for performing shading, the operating method comprising:
determining setting values of heuristic precision modulated shading (PMS);
determining whether a branch is in a control flow graph (CFG);
based on the branch not being in the CFG, setting a precision mode of instructions of the CFG to a basic brain floating point (BF) mode;
based on the branch being in the CFG, identifying a last branch in the CFG and setting the precision mode of the instructions of the CFG to the basic BF mode, based on execution of the last branch being completed;
setting, to a high precision BF mode, a plurality of instructions of use-definition chain, from among the instructions of the CFG, corresponding to a use-definition chain of a source operand of the last branch; and
performing refining on remaining instructions of the CFG excluding the plurality of instructions of the use-definition chain.

10. The operating method of claim 9, wherein the determining of the setting values of the heuristic PMS comprises:
determining a maximum repetition depth value of the heuristic PMS based on at least one of the use-definition chain, a basic BF mode value, or a high precision BF mode value, the maximum repetition depth value indicating a number of instructions having to be set to the high precision BF mode; and
determining a minimum setting threshold value of the heuristic PMS, the minimum setting threshold value indicating a minimum number of instructions provided between precision mode switching.

11. The operating method of claim 9, wherein the setting, to the high precision BF mode, of the plurality instructions of the use-definition chain comprises:
setting, to the high precision BF mode, the precision mode of one or more instructions corresponding to a maximum repetition depth value from among the plurality of instructions of the use-definition chain.

12. The operating method of claim 9, wherein the performing of the refining on the remaining instructions comprises:
comparing a minimum setting threshold value with a number of instructions provided between precision mode switching;
determining whether the number of instructions is greater than the minimum setting threshold value; and
skipping an operation of changing the precision mode based on the number of instructions provided between the precision mode switching being less than the minimum setting threshold value.

13. The operating method of claim 9, wherein the heuristic PMS corresponds to fragment shading in a graphics pipeline.

14. The operating method of claim 9, further comprising:
generating an instruction instructing to change the precision mode,
wherein the instruction is configured not to be calculated in a scalar arithmetic logic unit (ALU).

15. An electronic device, comprising:
a memory; and
a processor comprising a shader engine configured to perform a graphics pipeline,
wherein the shader engine is configured to:
determine setting values of heuristic precision modulated shading (PMS),
determine whether a branch is in a control flow graph (CFG),
based on the branch not being in the CFG, set a precision mode of instructions of the CFG based on a basic brain floating point (BF) mode,
based on the branch being in the CFG, identify a last branch in the CFG and set the precision mode of the instructions of the CFG to the basic BF mode, based on execution of the last branch being completed,
set, to a high precision BF mode, a plurality instructions of use-definition chain, from among the instructions of the CFG, corresponding to a use-definition chain of a source operand of the last branch, and
perform refining on remaining instructions of the CFG excluding the plurality of instructions of the use-definition chain.

16. The electronic device of claim 15, wherein the shader engine is further configured to:
determine a maximum repetition depth value of the heuristic PMS based on at least one of the use-definition chain, a basic BF mode value, or a high precision BF mode value, the maximum repetition depth value indicating a maximum number of instructions having to be set to the high precision BF mode, and
determine a minimum setting threshold value of the heuristic PMS, the minimum setting threshold value indicating a minimum number of instructions provided between precision mode switching.

17. The electronic device of claim 15, wherein the shader engine comprises:
an instruction buffer configured to store instructions;
a controller configured to schedule execution of the instructions;
a scalar arithmetic logic unit (ALU) configured to perform a scalar operation;
a vector ALU configured to perform a vector operation;
a general-purpose scalar register configured to store a value of the scalar operation; and
a general-purpose vector register configured to store an intermediate value of the vector operation.

18. The electronic device of claim 17, wherein the instruction buffer further comprises:
a buffer logic configured to generate a scalar instruction instructing to change the precision mode.

19. The electronic device of claim 16, wherein the shader engine is further configured to:
set, to the high precision BF mode, the precision mode of one or more instructions corresponding to the maximum repetition depth value from among the plurality instructions of the use-definition chain.

20. The electronic device of claim 16, wherein the shader engine is further configured to:
compare the minimum setting threshold value with a number of instructions provided between precision mode switching,
determine whether the number of instructions is greater than the minimum setting threshold value, and
skip an operation of changing the precision mode based on the number of instructions provided between the precision mode switching being less than the minimum setting threshold value.
